(19) United States
(12) Patent Application Publication
(10) Pub. No.: US 2015/0168146 A1
(43) Pub. Date: Jun. 18, 2015

(54) PLANAR ACCELEROMETER WITH INTERNAL RADIAL SENSING AND ACTUATION

(71) Applicant: SENSORS IN MOTION, Seattle, WA (US)

(72) Inventors: Kirill V. Shcheglov, Los Angeles, CA (US); Nolan Maggipinto, Santa Barbara, CA (US); David Smukowski, Seattle, WA (US)

(21) Appl. No.: 14/569,539

(22) Filed: Dec. 12, 2014

Related U.S. Application Data
(60) Provisional application No. 61/916,005, filed on Dec. 13, 2013.

(51) Int. Cl. G01C 19/5719

(52) U.S. Cl. CPC G01C 19/5719

(57) ABSTRACT

An inertial sensor that includes a planar mechanical resonator with embedded sensing and actuation for substantially in-plane vibration and having a central rigid support for the resonator is disclosed. At least one excitation or forcing electrode is disposed within an interior of the resonator to excite in-plane vibration of the resonator, and at least one sensing or pickoff electrode is disposed within the interior of the resonator for sensing the motion of the excited resonator. In one embodiment, the planar resonator includes a plurality of slots in an annular pattern around the central rigid support. The planar resonator has a simple pair of in-plane vibration modes.

### PRIORITY CLAIM

The present application claims priority to U.S. Provisional Patent Application Ser. No. 61/916,005, filed Dec. 13, 2013, entitled “Planar 2-D accelerometer with internal radial sensing and actuation.”

### BACKGROUND

1. Field

The present disclosure relates generally to accelerometers and, in particular, to resonator micro accelerometers or inertial sensors and their manufacture. More particularly, the present disclosure relates to isolated resonator inertial sensors and micro accelerometers.

2. Related Art

Mechanical accelerometers are used to determine linear direction of a moving platform based upon the sensed inertial reaction of an internally moving proof mass. In various forms accelerometers are often employed as a critical sensor for vehicles, such as aircraft and automobiles. They are generally useful for navigation, stabilization, crash sensing, and pointing or whenever it is necessary to autonomously determine the acceleration or motion of a free object.

A typical electromechanical accelerometer includes a suspended proof mass, accelerometer case, pickoffs (or sensors), forcers (or actuators) and readout electronics. The inertial proof mass is internally suspended from the accelerometer case. The accelerometer case is rigidly mounted to the platform. The accelerometer case communicates the inertial motion of the platform while otherwise isolating the proof mass from external disturbances. The pickoffs sense the internal motion of the proof mass, and the forcers maintain or adjust this motion. The readout electronics must be in close proximity to the proof mass, and are internally mounted to the case which also provides the electrical feed-through connections to the platform electronics and power supply. The case also provides a standard mechanical interface to attach and align the accelerometer with the vehicle platform.

Older conventional mechanical accelerometers were very heavy mechanisms by current standards, employing relatively large masses. Existing MEMS (micro-electro-mechanical systems) accelerometers, on the other hand, utilize small masses with small electrodes. However, these MEMS accelerometers suffer from two issues:

1. The small mass provides for a small reaction force to acceleration and also for a larger native resonator noise level stemming from simple thermodynamic considerations; and

2. The small electrodes lead to small sensing capacitance and thus to small signal levels which degrade the SNR (signal-to-noise ratio) thus compromising the sensor performance.

### SUMMARY

The following summary is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Embodiments of the invention relate to a planar resonator supported on a central rigid stem. The planar resonator has substantially increased sensing capability because it utilizes a short cylindrical resonator or disc having an internal volume for incorporating actuating and sensing electrodes within the resonator itself. Additionally, the resonator body is solid, which also substantially increases the sensing capability.

In one embodiment, the accelerometer is a disc-shaped mass having multiple circumferential slots therein. These slots form three different structures: a flexible support attached at the center allowing the lateral vibration of the mass about the central support; multiple excitation (forcing) electrodes, and multiple sensing electrodes. In addition, tuning electrodes may be housed within the structure of the mass.

Because the resonator is planar, its manufacture is conveniently facilitated through known wafer manufacturing technologies. For example, the planar resonator can be produced by reactive ion etching (RIE) the resonator from silicon bonded in place on a supporting silicon baseplate. Electrode support pillars and interconnect wiring can be etched and deposited on the baseplate before bonding. The etching process can thus be used to simultaneously produce the driving excitation and pickoff sensing electrodes along with the resonator and a portion of the accelerometer case. For example, the etching process can be used to produce a wall that surrounds the resonator. A third silicon wafer, having the readout electronics and electrode interconnections, may be bonded to the resonator to complete the sensor assembly.

According to one aspect of the invention, an inertial sensor is disclosed that includes a planar resonator for in-plane vibration with two in-plane vibration modes and having a central mounting point, a plurality of compliance elements etched in the planar resonator around the central mounting point and a plurality of slots arranged in a symmetrical pattern around the compliance elements; a support to support the planar resonator at the central mounting point; at least one excitation electrode within at least one of the plurality of slots of the planar resonator to excite vibration of the two vibration modes; and at least one sensing electrode within at least one of the plurality of slots of the planar resonator for sensing the two vibration modes.

The in-plane vibration may include in-plane lateral motion about the central mounting point.

The inertial sensor may further include a baseplate supporting the support, the at least one excitation electrode and the at least one sensing electrode.

The plurality of slots may be arranged in an annular pattern around the central mounting point. The plurality of slots may include one or more inner slots and one or more outer slots. The at least one excitation electrode may be disposed within the one or more outer slots. The at least one sensing electrode may be disposed within the one or more inner slots.

The inertial sensor may further include an integral case vacuum wall. The planar resonator may be fabricated from a wafer, and the case vacuum wall may be formed from said wafer.

The inertial sensor may further include an end cap wafer. The end cap wafer may be bonded to a case wall with a vacuum seal. The end cap wafer may include readout electronics for the inertial sensor.

The plurality of compliance elements may include internal surfaces for actuating the two vibration modes.

The planar resonator may include a resonator body, and the plurality of compliance elements and the plurality of slots may be openings formed in the resonator body. The resonator body may include a proof mass. The plurality of compliance elements may provide flexural suspension for the proof mass.

According to another aspect of the invention, an inertial sensor is disclosed that includes a resonator body having a central mounting point; a plurality of radial segment openings in the resonator body around the central mounting point; a plurality of slot openings in the resonator body around the plurality of radial segment openings, wherein the plurality of slot openings are symmetrically arranged in the resonator body; a plurality of excitation electrodes in at least four of the plurality of slot openings; and a plurality of sensing electrodes in at least four of the plurality of slot openings.

The inertial sensor may further include at least one tuning electrode in at least one of the plurality of slot openings.

The inertial sensor may further include an end cap wafer and a base plate bonded to the planar resonator, and the base plate may support the planar resonator at the central mounting point.

The plurality of slot openings may include a plurality of inner slot openings and a plurality of outer slot openings, and the plurality of excitation electrodes may be in the plurality of outer slot openings, and the plurality of sensing electrodes may be in the plurality of inner slot openings.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIG. 1A is a top view of an exemplary planar resonator accelerometer according to one embodiment of the invention.

FIG. 1B is a side view of an exemplary planar resonator accelerometer according to one embodiment of the invention.

FIG. 1C is a schematic diagram of an exemplary slot pattern for a planar resonator accelerometer according to one embodiment of the invention.

FIG. 1D is a schematic diagram illustrating the electrode pattern for an exemplary resonator according to one embodiment of the invention.

FIGS. 2A-2B are top views of exemplary masks that can be used to produce an isolated planar resonator according to embodiments of the invention.

FIGS. 3A-3R depict stages of an exemplary manufacturing process according to one embodiment of the invention.

FIG. 4 is a schematic diagram illustrating an integrated end cap wafer including the control electronics according to one embodiment of the invention.

FIG. 5 is a schematic diagram showing a sensor packaging assembly according to one embodiment of the invention.

### DETAILED DESCRIPTION

In the following description of embodiments of the invention, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Overview

Embodiments of the invention generally relate to an isolated planar vibratory accelerometer. The isolated planar vibratory accelerometer employs embedded sensing and actuation, and includes an axisymmetric resonator having a single central support, integral (and distributed) proof mass, flexural suspension and extensive capacitive electrodes, with a large total capacitance. The isolated resonator described herein is for in-plane vibration, and, in particular two in-plane vibration modes suitable for acceleration sensing are provided.

### Isolated Planar Resonator Accelerometer

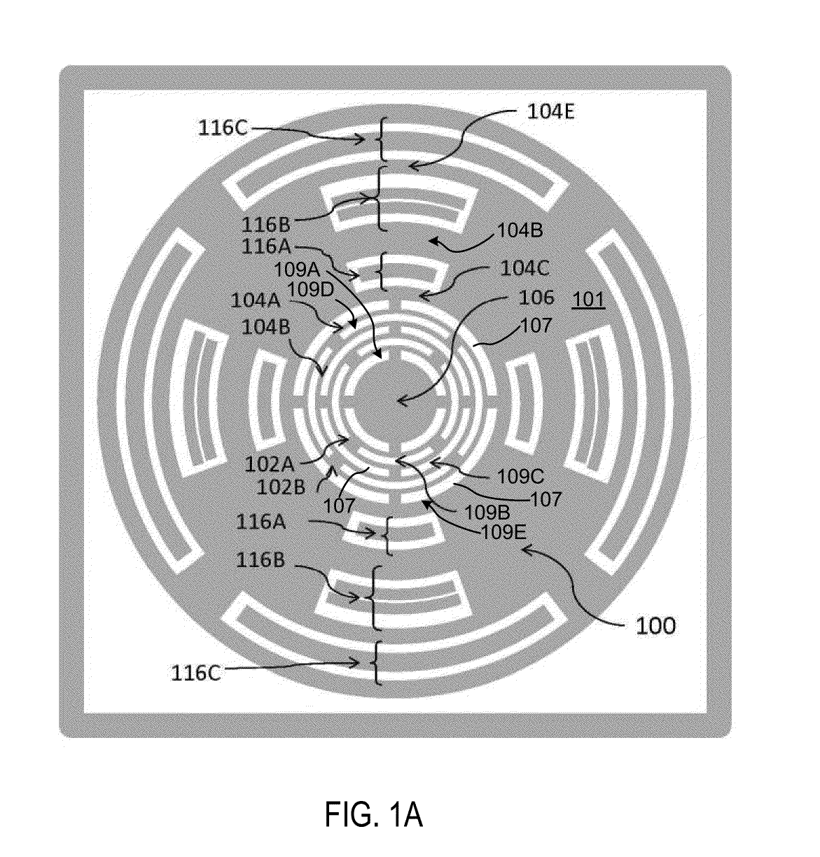

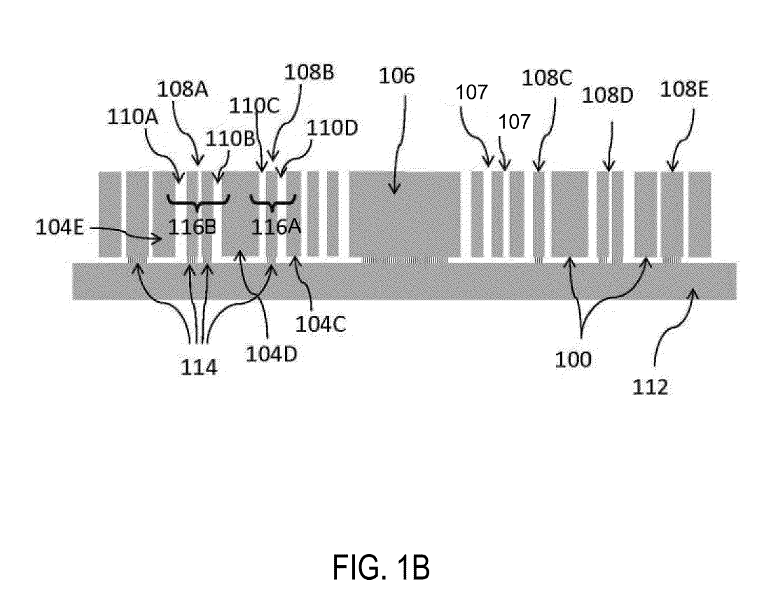

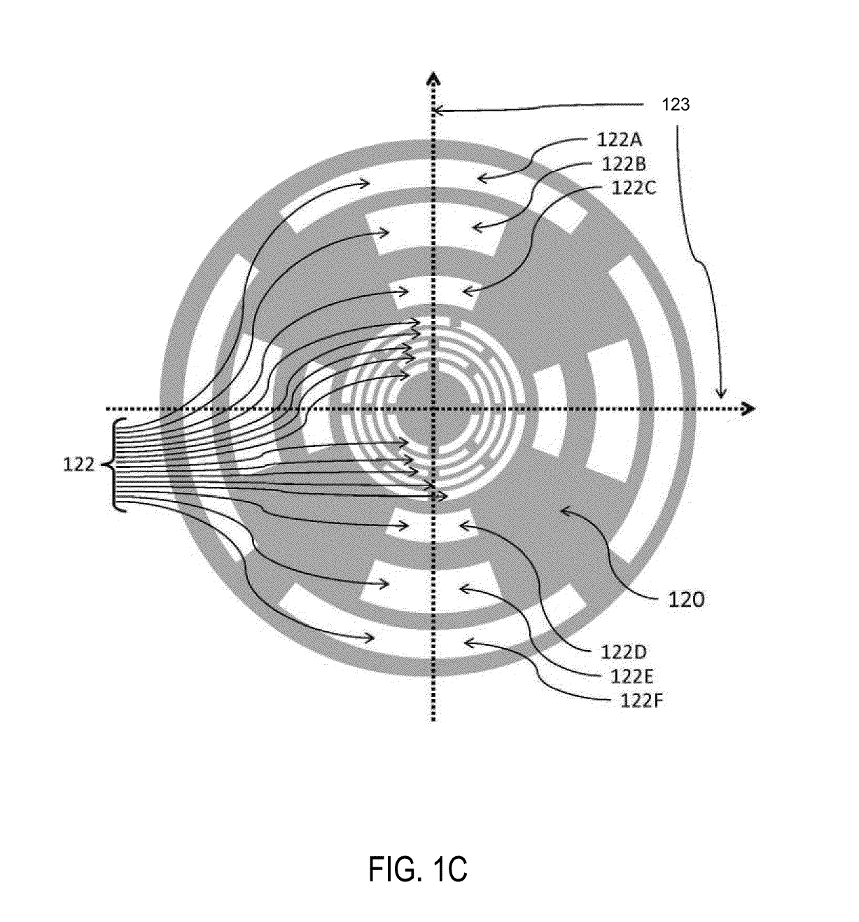

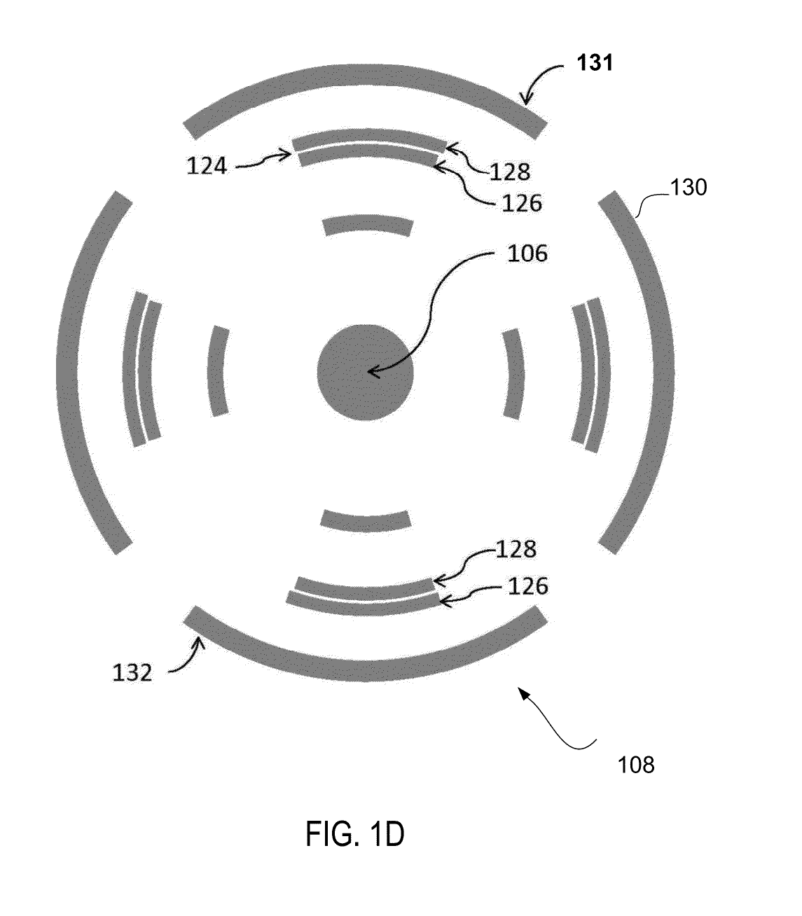

FIGS. 1A-1D illustrate a planar resonator accelerometer in accordance with embodiments of the invention. FIG. 1A is a schematic top view of an isolated resonator for the accelerometer or inertial sensor, FIG. 1B a schematic cross-section view of the isolated resonator, FIG. 1C is a schematic diagram of an exemplary pattern for forming the isolated resonator and FIG. 1D illustrates electrodes incorporated within the isolated resonator. An inertial sensor is a sensor used to determine motion, such as acceleration, of a moving platform by sensing the inertial reaction of a proof mass. The planar resonator accelerometer shown in FIGS. 1A-1D may be micro-machined.

As in FIG. 1A, the accelerometer includes a unique planar resonator 100 shown. The resonator 100 includes a disc-shaped resonator body 101. The resonator body 101 includes a central support 106. The resonator body 101 acts as an integral proof mass of the resonator.

The overall diameter of the resonator 100 can be varied depending upon the performance requirements. For example, an 8 mm diameter resonator can provide relatively high machining precision and low noise while a 4 mm diameter resonator can provide an attractive tradeoff between size, cost and performance. Further refinement of the resonator can yield a resonator diameter of only 2 mm at significantly reduced cost. It will be appreciated that the diameter of the resonator may be any value or range of values between about 2 mm and 8 mm, and that the diameter may be less than 2 mm or greater than 8 mm.

Although the exemplary resonator 100 is shown as a disc, other planar geometrics are also possible, applying principles of the invention. However, the circular disc-like shape has a distinct advantage in that the rotational mode motion is well separated from the translational mode motion and thus is not sensed by the circumferential electrode arrangement, and second order effects are not sensed.

As shown in FIG. 1B, the resonator 100 is assembled onto a baseplate 112, and the central support 106 supports the resonator 100 on the baseplate 112. The single central support 106 provides isolation of the resonator 100 from external stresses and vibration. It will be appreciated, however, other mounting configurations using one or more additional or alternate mounting supports are also possible.

With reference back to FIG. 1A, the resonator body 101 includes a number of compliance elements 107 and a number of sensing and excitation elements 116. In FIG. 1A, the compliance elements are circumferentially arranged around the central support 106, and the sensing and excitation elements 116A-C are concentrically arranged around the compliance elements. The resonator body 101 includes a number of circumferential segments 104 and radial segments 102 which form part of the integrated and distributed arrangement of the proof mass.

In some embodiments, some or all of the segments 104A-104E can be further slotted such that a single segment is further divided into a composite segment including multiple parallel segments. Selective use of such composite segments can be used to adjust the frequency of the resonator. Generally, adding slots to form composite circumferential segments lowers the resonator frequency. The effect of machining errors is also mitigated with multiple slots. Although such composite segments may be applied to the circumferential segments 104A-104E, the technique can also be applied to the radial segments 102A-102B, or designs with other segments in other resonator patterns.

In FIG. 1A, five rings 109 of compliance elements 107 are provided: 109a-109e. The rings 109 are arranged in the resonator body between the central support 106 and the sensing and excitation elements 116. In FIG. 1A, each ring 109 includes four compliance elements 107. In FIG. 1A, the compliance elements 107 are offset relative to compliance elements in adjacent rings 109. It will be appreciated that the number of compliance elements 107 and the number of rings 109 may differ from that shown in FIG. 1A. For example, fewer or more than five rings 109 may be used and fewer than or more than twenty compliance elements 107 may be provided. The thickness of the compliance elements may be any value or range of values between about 1-10 μm; it will be appreciated that they may be greater than 10 μm. The compliance elements 107 impact the compliance of the resonator body 101, and thus the amount of vibration that can be induced and sensed by the accelerometer.

The sensing and excitation elements 116 include slots (or openings) formed in the resonator body 101 and electrodes formed in those slots such that the electrodes are embedded in the resonator body 101, as shown in FIG. 1B. As shown in FIG. 1A, the sensing and excitation elements 116A-C are arranged between the compliance elements 107 and the circumference of the resonator body 101. In FIG. 1A, the sensing and excitation elements 116A-C illustrate the sensing and excitation elements of one quadrant of the resonator; it will be appreciated that the electrode slots for the other quadrants of the resonator are similar to those of electrode slots 116A-C. As shown in FIG. 1A, element 116A is a tuning element, element 116B is a sensing element and element 116C is an excitation (or driving) element.

As shown in FIG. 1B, openings of the sensing and excitation elements 116 in the resonator 100 provide access for embedded electrodes 108A-108D which are also supported on pillars 114 on the baseplate 112. The electrodes 108A -108D form capacitive gaps 110A-110D (outward gaps 110A and 110C and inward gaps 110B and 110D) with at least some of the circumferential segments 104C-104E of the resonator 100.

FIG. 1C illustrates a pattern 120 of the slots or openings that form the compliance elements 107 and sensing and excitation elements 116 in further detail. The pattern 120 employs numerous concentric annular slots 122. The slots 122 are arranged symmetrically throughout the resonator body. Some of the slots, e.g. 122A-122E, are wider to accommodate multiple element electrodes. For example, the sensing electrodes may be provided in the inner slots 122B, and the driving (or excitation) electrodes may be provided in the outer slots 122A. As an alternative to the configuration shown in FIG. 1C, the slots 122B, 122E can be divided into two smaller slots (as opposed to one larger slot), such that one electrode is provided in each of the slots instead of a pair of electrodes in each slot. A uniform radial spacing between slots 122 can be employed between adjacent slots 122, but non-uniform spacing may also be used, provided two in-plane modes suitable for acceleration sensing are maintained.

The slots or openings 122A-F are sized such that the electrodes can be formed in the slots and will depend on the manufacturing process and materials used to form the electrodes. The size of the slots 122A-F may be any value or range of values between about 5-200 μm wide. It will be appreciated however that the size may be less than 5 lam or greater than 200 μm.

FIG. 1C also illustrates the resonator and modal axes 123 of the resonator. The modal axes 123 are the axes of the two modes of resonation. The acceleration is driven and sensed along the modal axes 123. As shown in FIG. 1C, the modal axes 123 are perpendicular to one another. The modal axes 123 are both in the plane of the sensor (i.e., both vibration modes are in-plane). As shown in FIG. 1C, the pattern 120 is symmetric and the slots 116 are arranged along the modal axes 123. A combination of accelerations (or forces) measured can be used to determine the component parts of the force.

Although the slots 122 can be formed in the resonator 100 along directions differing from annular, the annular slots are advantageous because they provide a geometric rejection of unwanted vibration modes for driving, sensing and tuning the resonator. Such unwanted modes include rotational modes, as well as higher order vibration modes of the disc.

The electrodes 108 that are embedded in the slots 122 are shown in FIGS. 1B and 1D. With reference to FIG. 1B, the electrodes 108A -108D provide for lateral excitation of the resonator 100 as well as sensing the motion of the resonator 100. To facilitate this, each of the electrodes 108A-108D is divided into multiple separate elements to improve control and sensing of the resonator by exciting and sensing the motion in a differential manner. For example, the annular electrode 108A, as shown, can be divided into two or more elements, at least one element acting across the outward gap 110C and at least one element acting across the inward gap 110D. Vibration is induced in the resonator by separately exciting the elements to produce a biased reaction on the resonator 100 at the electrode 108A location.

FIG. 1D illustrates the electrodes 108 in further detail. Two groups of excitation electrodes are used, each at a 180° interval around the circumference of the pattern. Each group of excitation electrodes includes a positive excitation element 131 and a negative excitation element 132. The paired excitation elements 131, 132 are driven to excite the resonator 100.

The sensing electrodes are disposed at an intermediate radial position and also include positive sensing elements 128 and negative sensing elements 126 which together provide output regarding motion of the resonator. The sensing electrodes 126, 128 are positioned in the same slot in the configuration shown in FIGS. 1A-1B. In the slot, the positive elements 128 are in the inner position (closer to the central support 106) and the negative elements 126 are in the outer position (closer to excitation electrodes 131, 132).

Tuning electrodes may be provided in slots 122C. These tuning electrodes can actively tune the resonator in operation through electrostatic tuning In some embodiments, the tuning electrodes may be used to lower the resonance frequency and thus increase the sensitivity of the sensor. Given sufficient tuning authority the resonant frequency may be tuned all the way to 0 Hz thus producing a sensor with an effectively free mass element. This may be advantageous where accelerations are small—the acceleration inputs may be integrated by the element itself up to some small displacement limit, thus bypassing some of the errors inherent in electronic and numerical integration of the acceleration input to calculate position. It is also possible, given a pair of such accelerometers, to continuously use at least one in a self-integrating mode while the other's mass position is being reset.

The arrangement and distribution of the excitation and sensing electrodes 108 can be varied as desired, however, since electrodes spanning the same angular arc but located farther away from the center will have a larger capacitance (and thus a larger signal or excitation authority), placement of the electrodes will vary depending on SNR and dynamic range requirements. This aspect constitutes one of the ways the design can be scaled to meet varying sensor needs. For example, accelerometer applications for measuring gravity (i.e. inclinometer) may have a different placement of electrodes than accelerometer applications for measuring accelerations that have more variance. The placement of the electrodes changes the capacitance and thus impacts the changes in capacitance that can be sensed by the electrodes.

In one embodiment, the sensing electrodes are used to sense the displacement of the proof mass due to applied acceleration along the directions of the two axes. The excitation electrodes are then energized such that the displacement is zeroed out and the mass is returned to its nominal position. The force applied by the excitation electrodes required to keep the proof mass from moving is directly related to the applied acceleration. In another embodiment, the excitation electrodes 131, 132 within the resonator 100 are driven to induce vibration in the resonator 100. Because of the arrangement of the electrodes, vibration is induced in two different modes of vibration corresponding to the modal axes 123. Movement of the platform to which the accelerometer is attached causes changes in the vibration of the resonator 100. The sensing electrodes 126, 128, also within the resonator 100, sense these changes in vibration as a measurement of force along the modal axes. The acceleration corresponding to the two modes of vibration 123 can then be determined from the force measurement.

As employed in the resonator 100 described above, a centrally supported solid cylinder or disc has two in-plane modes suitable for acceleration sensing. The multi-slotted disc resonator 100, shown in FIGS. 1A-1D overcomes several problems associated with prior art accelerometers. By etching multiple annular slots through the cylinder or disc, two immediate benefits result: (1) two modes suitable for acceleration sensing with low frequency (less than 50 KHz) and (2) large sense, bias and drive capacitance. The low frequency derives from the increased in-plane compliance provided by the compliance elements. The large sense, bias and drive capacitance is a consequence of the large number of slots 122 that can be machined into the resonator. Additional advantages include, that the central support bond tends to resolve and block external stresses and keeps them from interfering with the resonator motion. In addition, simultaneous photolithographic machining of the resonator and electrodes is achieved via the slots. Furthermore, paired electrode capacitances can be summed to eliminate vibration rectification and axial vibration does not change capacitance to a first order. Modal symmetry is also largely determined by photolithographic symmetry not wafer thickness as with other designs. Isolation and optimization of sense capacitance (e.g., from the inner slots) and drive capacitance (e.g., from the outer slots) is achieved. Embodiments of the invention also achieve a geometric scalable design to smaller or larger diameters and thinner or thicker wafers. In addition, embodiments of the invention can be entirely defined by slots of the same width for machining uniformity and symmetry.

In further embodiments of the invention, the multiple ring structure with staggered or interleaved radial segments, such as illustrated in FIG. 1A, can be used without internal sensing/actuation. This resonator architecture can provide the advantages of averaging of machining errors, higher natural frequency with thinner silicon rings and higher Q (lower thermoelastic damping) when compared with resonators employing a single ring and “wagon wheel” spokes from a central hub. The utility of this resonator structure is to provide multiple thin silicon rings with useful sturdy support to a central hub. Such a resonator can be employed whether or not internal actuation and sensing is also used. Furthermore, although it is desirable to employ a central mounting point, it will be appreciated that more one central mounting point may be used. Staggering or interleaving the radial segments indicates not all the radial segments form straight lines from the center of the resonator to the periphery (although some may). It should also be noted that the term “ring” as used herein does not require a circular shape. For example, the circumferential segments forming the concentric rings of the resonator of FIG. 1A may instead form a polygon. Circular rings are desirable, but other closed shapes can be used.

### Exemplary Process for Producing an Exemplary Isolated Planar Resonator Accelerometer

FIGS. 2A and 2B illustrate masks that can be used to produce an isolated resonator. FIG. 2A illustrates a top view of the multi-slotted disc resonator fabrication pattern 200, and FIG. 2B illustrates a top view of the multi-slotted disc baseplate pattern 208.

As shown in FIG. 2A, the resonator fabrication pattern 200 includes a large central area 202 which is bonded to the central support on the baseplate. The embedded electrodes, e.g. concentric annular electrodes 204A-204C, are defined by the through etching process that simultaneously defines the structure 206 (radial and circumferential segments) of the resonator.

As shown in FIG. 2B, the multi-slotted disc baseplate pattern 208 includes the bonding pads, e.g., electrode bonding pads 210A-210C and the central support bonding pad 212.

For a mesoscale (greater than 8 mm) accelerometer, a 500 micron wafer, e.g. silicon, can be through-etched with circumferential slot segments to define a planar disc resonator with embedded electrostatic sensors and actuators. Integral capacitive electrodes can be formed within these slots from the original resonator silicon during the through etch process. This can be accomplished by first bonding a blank resonator wafer to a base silicon wafer that is specially prepared with circumferential bonding pillar segments to support the stationary electrodes and central resonator. The pillar heights may be defined by wet chemical etching and fusion bonding can be used to bond the resonator to the support pillars before the resonator and its electrodes are photolithographically machined using deep reactive ion etching (DRIE).

In addition, for a microscale (4 mm) resonator a 125 micron thick silicon wafer, silicon on insulator (SOI) or epitaxial silicon layer may be used for the resonator wafer. It will be appreciated that other materials may be used for the wafer, including, for example, fused silica, fused alumina, sapphire, metallic glass, quartz, diamond, silicon germanium and the like. It will be appreciated that a thicker wafer can be bonded to the baseplate and then ground down and polished to the desired thickness. The dense wiring can be photolithographed onto the baseplate before resonator bonding and wirebonded outside the device to a wiring interconnect grid on a ceramic substrate in a conventional vacuum packaging or interconnected to a readout electronics wafer via vertical pins etched into the resonator for a fully integrated silicon accelerometer that does not require a package. Alternately, an electrical wafer containing metallization that carries signals to and from the respective electrodes, combines them appropriately and connects them to wire-bonding pads at the die periphery can be bonded to the resonator wafer to connect all the appropriate electrodes and to form an enclosed cavity around the resonator.

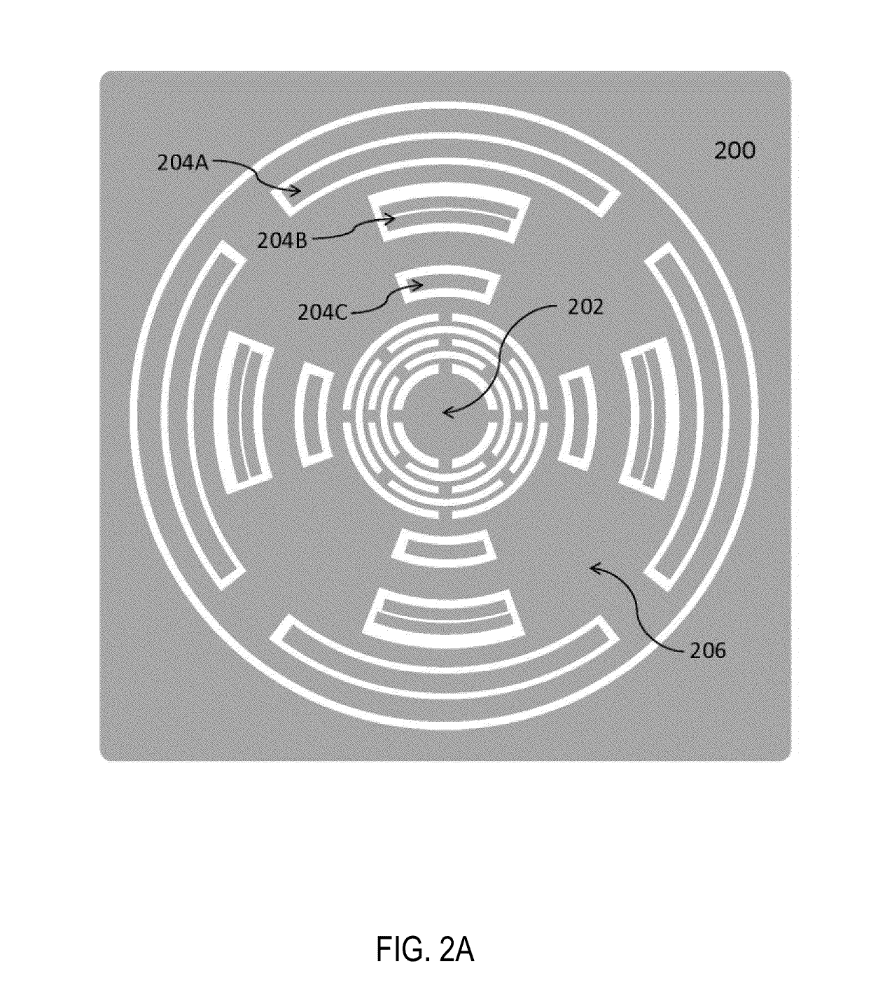

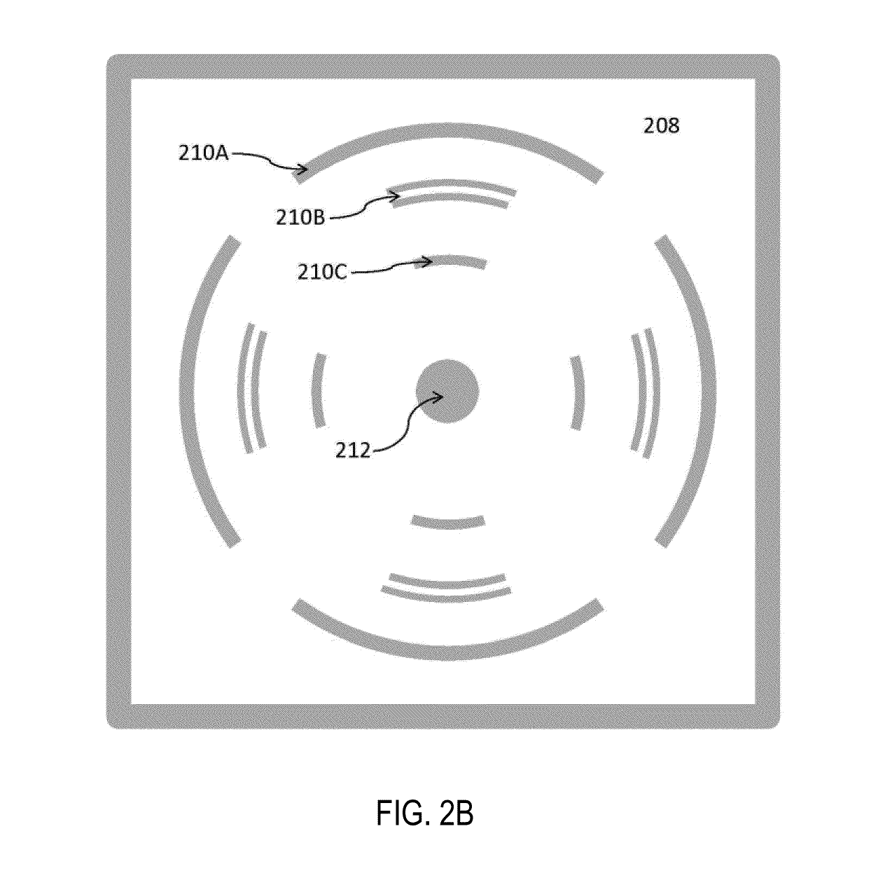

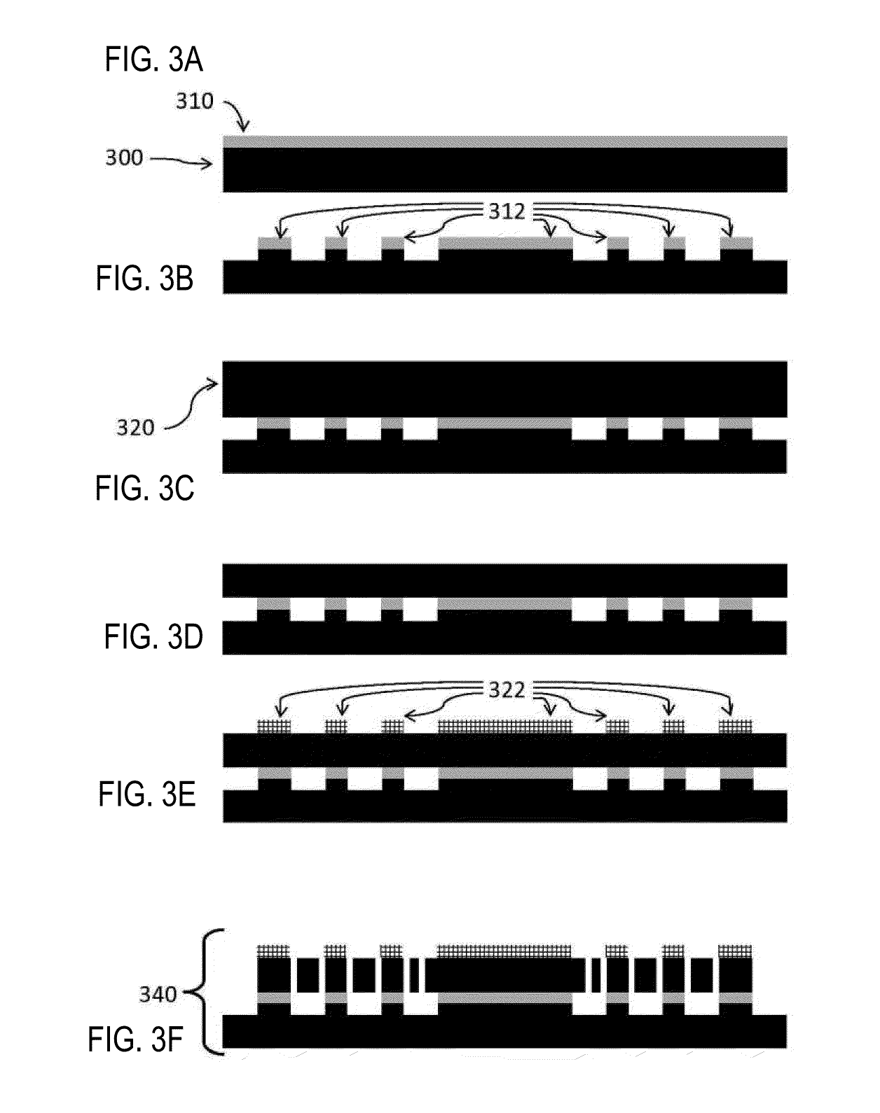

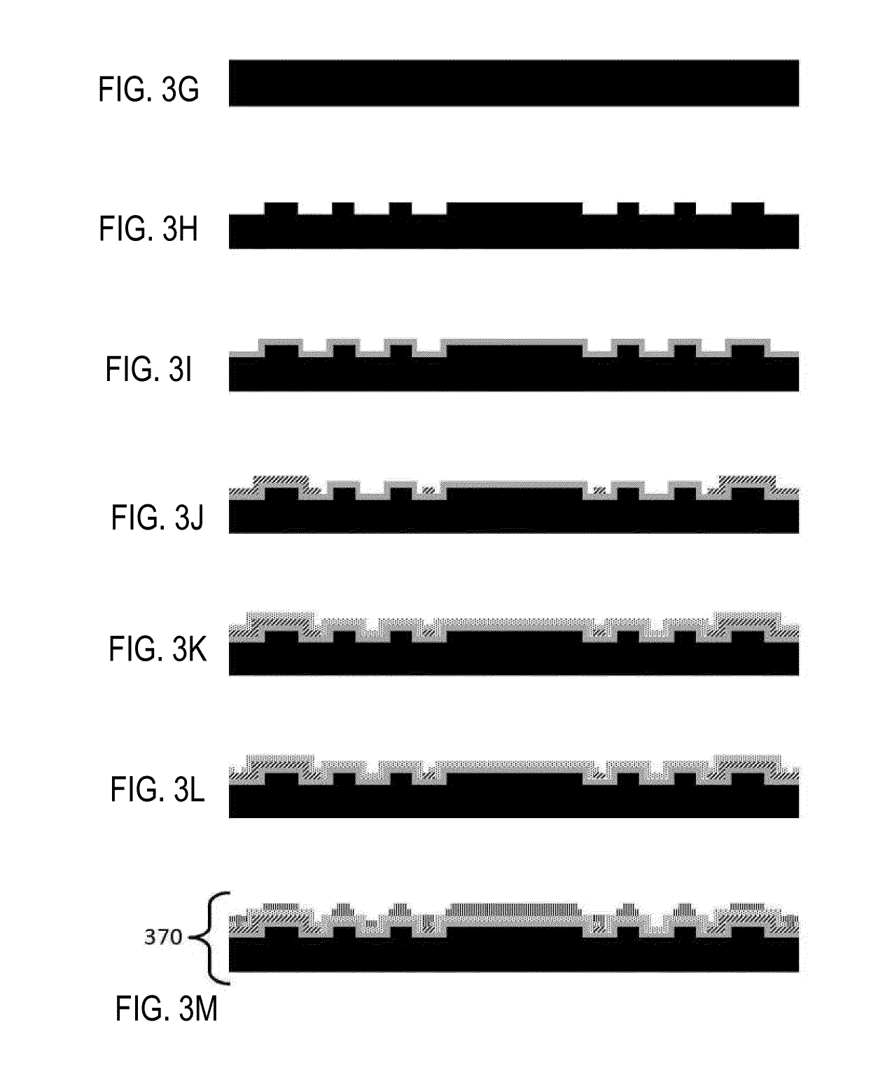

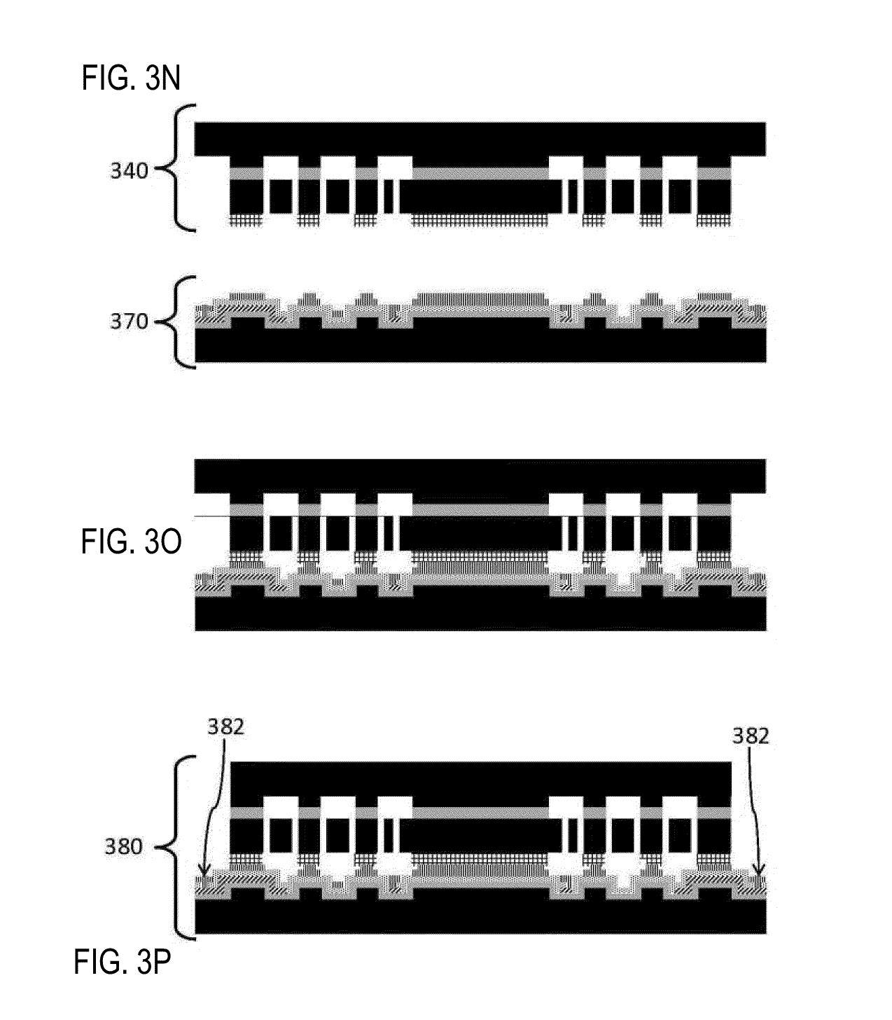

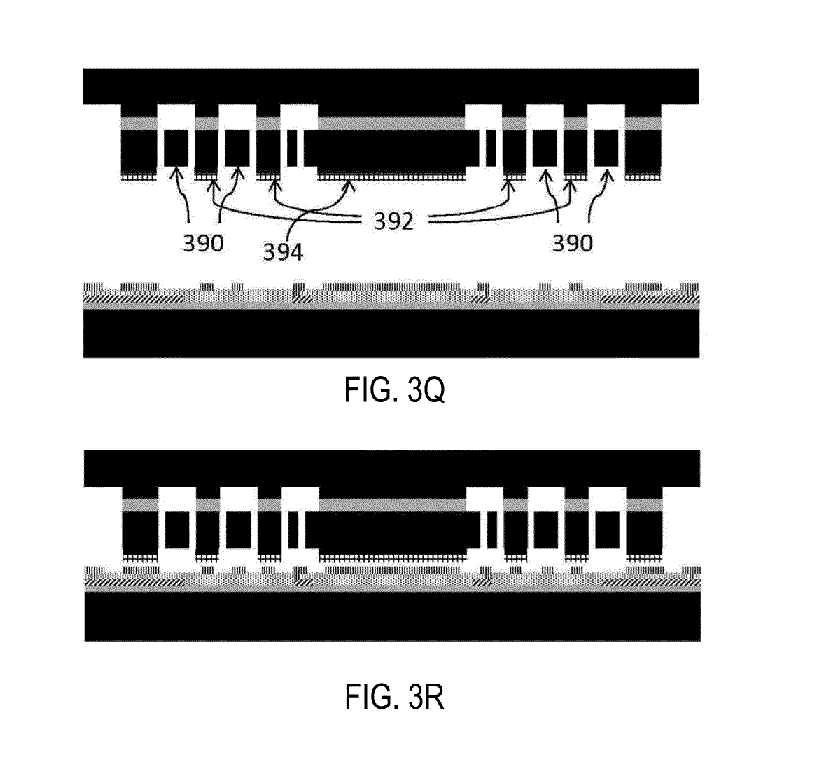

FIGS. 3A-3R depict various stages of an exemplary manufacturing process for the invention. FIGS. 3A-3F shows a sequential development of the baseplate/resonator pair 340 for the accelerometer. The process begins with a wafer 300, which has thermal oxide 310 grown on it via a wet thermal oxidation process, as shown in FIG. 3A. In some embodiments the wafer 300 is a 500 micron silicon wafer.

The oxide is patterned and etched back, possibly into the underlying wafer, to firm pillars 312 that support the electrodes (not shown) and the resonator (not shown), as shown in FIG. 3B. The resulting structure is the baseplate 112. The etching can be performed via a wet chemical etch, such as buffered oxide etch (BOE) for oxide and potassium hydroxide (KOH) for silicon, or, alternately can be dry etched using Reactive Ion Etching (RIE) in a plasma RIE tool such as an STS advanced oxide etch (AOE) tool.

As shown in FIG. 3C, a blank silicon 320 resonator wafer is subsequently bonded to the baseplate. In some embodiments, the wafer is a silicon wafer. The wafer may be bonded using, for example, fusion bonding or plasma surface activated bonding. As shown in FIG. 3D, the silicon wafer may then be ground and polished.

A metal pattern 322 corresponding to the electrode pattern is then deposited onto the resonator wafer, as shown in FIG. 3E. In one embodiment, the metal pattern 322 is deposited using thermal evaporation. Alternatively, the metal pattern may be deposited using sputtering or other metal deposition techniques known to those of skill in the art. In one embodiment, the metal pattern 322 comprises deposition a titanium (Ti) adhesion layer, a tungsten (W), Ti—W, platinum (Pt), or chromium (Cr) diffusion barrier layer and a gold (Au) layer. It will be appreciated that other metals or alloys may be used for the layers and that fewer or more than three layers may be used to form the metal pattern 322.

Finally, the resonator wafer is patterned and through etched as shown in FIG. 3F. The through etching may be done using an appropriate DRIE tool, such as an STS silicon DRIE. The patterning and through etching form the resonator 326 and the electrodes 328. The patterning and through etching may also form a portion or all of an integral case vacuum wall.

FIGS. 3G-3M show a sequential development of the electrical wafer 370 for the accelerometer. The electrical wafer 370 includes the electrical connections between the resonator wafer 340 and the control electronics.

The process begins with a blank wafer as shown in FIG. 3G. The blank wafer surface is patterned and etched back to form pillars 352, as shown in FIG. 3H. The pillars 352 provide contact points for connecting the electrodes 328 to the resonator.

The wafer is then oxidized as shown in FIG. 3I. For example, approximately 3 micrometers of thermal oxide 354 may be grown on the wafer. Any thermal oxidation process may be used to oxidize the wafer. It will be appreciated that more than or less than three micrometers of thermal oxide 354 may be grown.

Subsequently, a metal pattern 356 is deposited onto the wafer (metal 1), as shown in FIG. 3I. In one embodiment, metal 1 consists of multiple layers of metals (e.g., titanium, gold, titanium). Alternatively, metal 1 may consist of a single metal (e.g., titanium or gold).

A PECVD oxide or another insulator layer 358 is then deposited covering the metal, as shown in FIG. 3J. Vias 360 are then etched in the insulator layer to provide for contact points with the underlying metal 1 layer 356, as shown in FIG. 3K.

A second metal pattern 362 is deposited (metal 2) making connections with the metal 1 pattern through the vias 360 in the insulator layer 358, as shown in FIG. 3L. In one embodiment, metal 2 includes titanium (Ti) or titanium tungsten (Ti—W). A third layer of metal may be deposited in certain locations to enable a solder bond with the resonator, or to compensate for height non-uniformity between different pillars. Such a non-uniformity may arise is the insulator layer is subjected to a polishing step to help planarize the surface to insure a vacuum-tight bond around the periphery of the device chip. For example, a layer of gold (Au) may be deposited on top of metal 2.

FIGS. 3N-3P show integration of the baseplate/resonator wafer 340 and the electrical wafer 370 and formation of the functional accelerometer sensor 380. The preprocessed baseplate wafer and resonator wafer 340 are aligned as shown in FIG. 3N. The preprocessed baseplate wafer and resonator wafer pair 340 is then bonded to the electrical wafer 370, as shown in FIG. 3O. In one embodiment, thermal compression bonding is used; however, it will be appreciated that alternative bonding techniques may be used, as known to those of skill in the art. Bonding fuses the gold on the electrodes to the gold on the electrical wafer pillars and can be performed at approximately 350° C.

Next, the wafer is diced, first to reveal the wire-bonding pads 382 at the die periphery, and subsequently to part the wafer into individual die, as shown in FIG. 3P. The individual die can then be packaged as understood by those of skill in the art. For example, the exemplary planar silicon resonator accelerometer embodiments presented herein can be assembled with conventional vacuum packaging and discrete electronics in a manner similar to previous accelerometers. An internal ceramic substrate wiring bonded to the silicon accelerometer baseplate may be used to match the new and old designs to existing packages.

FIGS. 3Q-3R illustrate another embodiment in which the resonator 390 is etched back to allow the electrodes 392 and central support 394 to contact a flat electrical wafer while still providing clearance for the resonator to move freely. In this configuration, an etch mask, such as polyimide, is applied, covering the electrodes while leaving the resonator area uncovered. A subsequent dry etch lowers the resonator surface to create the desired clearance (approximately 4-8 micrometers). The mask is subsequently removed by a dry etch process, such as oxygen plasma ashing or UV ozone ashing. The remaining nonvolatile solids may then be removed by a wet wash and rinse.

Since the planar resonator to baseplate bond can be accomplished by a robust fusion bond, an Au—Au thermal compression approach can be used for end cap wafer to resonator wafer bond stable at temperatures up to approximately 350° C. This allows the accelerometer to operate in a temperature environment as high approximately 250° C., if needed. The silicon planar resonator wafer and baseplate pair can be bonded directly to a readout electronics wafer containing CMOS control electronics 410 in order to reduce the trace and wirebond stray capacitance. By connecting the accelerometer sense and control electrodes directly to the control electronics on the Si readout electronics wafer using Au—Au thermal compression or an Au—Sn solder bonding, the overall robustness to high g-loading and thermal variations can be increased. In addition, since the accelerometer structure will form part of the readout electronics wafer, the electronics integration and the wafer vacuum encapsulation is accomplished in one fabrication step. This increased level of integration can also lead to significant cost reduction as expensive sequential steps such as packaging and electronics integration are omitted.

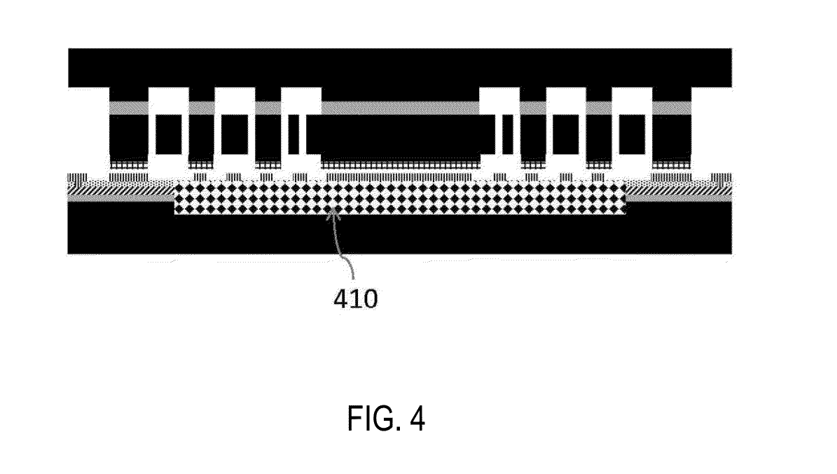

FIG. 4 illustrates an accelerometer 400 that includes a flat electrical wafer 404. Control electronics 410 may be incorporated into the wafer 404, as shown in FIG. 4. This arrangement provides for a higher level of integration and a reduction in sensor cost.

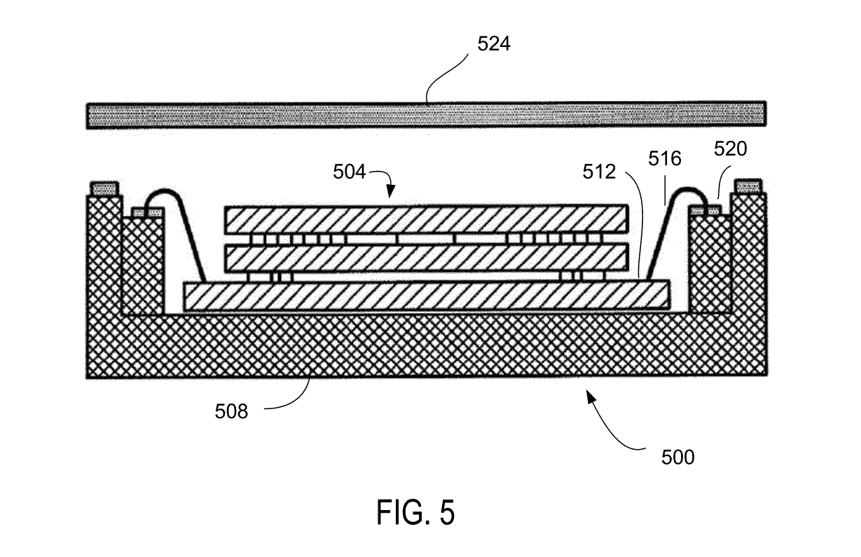

FIG. 5 shows an exemplary inertial sensor chip 504 in a typical packaging assembly 500. The inertial sensor chip 504 may include the planar resonator accelerometer described herein, such as the planar resonator accelerometer described above with reference to FIGS. 1A-1D. The inertial sensor chip 504 is attached to the package 508 using a solder preform or low outgassing epoxy. The die signal pads 512 are wire-bonded 516 to the appropriate package pads 520. A lid 524 is subsequently attached to the package 508, sealing the inertial sensor chip 504 in a hermetic cavity.

A proper choice of the device wafer pair and end cap wafer/device pair bonding methods is important to both ensure a tight vacuum seal and to maintain electrical connectivity and mechanical integrity. In particular, the device wafer pair should be bonded with a higher temperature process, such as a fusion bond, Au thermal compression or Au—Si eutectic, while the readout electronics wafer should be bonded with a lower temperature process, such as Au thermal compression, Au—Sn or Au—In. This is done to maintain the mechanical integrity of free-standing electrodes during the readout electronics wafer bonding phase.

The invention has been described in relation to particular examples, which are intended in all respects to be illustrative rather than restrictive. Those skilled in the art will appreciate that many different combinations will be suitable for practicing the present invention. Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. An inertial sensor comprising:
a planar resonator for in-plane vibration with two in-plane vibration modes and having a central mounting point, a plurality of compliance elements etched in the planar resonator around the central mounting point and a plurality of slots arranged in a symmetrical pattern around the compliance elements;
a support to support the planar resonator at the central mounting point;
at least one excitation electrode within at least one of the plurality of slots of the planar resonator to excite vibration of the two vibration modes; and
at least one sensing electrode within at least one of the plurality of slots of the planar resonator for sensing the two vibration modes.

2. The inertial sensor of claim 1, wherein the in-plane vibration comprises in-plane lateral motion about the central mounting point.

3. The inertial sensor of claim 1, further comprising a baseplate supporting the support, the at least one excitation electrode and the at least one sensing electrode.

4. The inertial sensor of claim 1, wherein the plurality of slots are arranged in an annular pattern around the central mounting point.

5. The inertial sensor of claim 1, wherein the plurality of slots comprises one or more inner slots and one or more outer slots.

6. The inertial sensor of claim 5, wherein the at least one excitation electrode is disposed within the one or more outer slots.

7. The inertial sensor of claim 5, wherein the at least one sensing electrode is disposed within the one or more inner slots.

8. The inertial sensor of claim 1, further comprising an integral case vacuum wall.

9. The inertial sensor of claim 8, wherein the planar resonator is fabricated from a wafer, and wherein the case vacuum wall is formed from said wafer.

10. The inertial sensor of claim 1, further comprising an end cap wafer.

11. The inertial sensor of claim 10, wherein the end cap wafer is bonded to a case wall with a vacuum seal.

12. The inertial sensor of claim 10, wherein the end cap wafer includes readout electronics for the inertial sensor.

13. The inertial sensor of claim 1, wherein the plurality of compliance elements comprise internal surfaces for actuating the two vibration modes.

14. The inertial sensor of claim 1, wherein the planar resonator comprises a resonator body, and wherein the plurality of compliance elements and the plurality of slots are openings formed in the resonator body.

15. The inertial sensor of claim 14, wherein the resonator body comprises a proof mass.

16. The inertial sensor of claim 15, wherein the plurality of compliance elements provide flexural suspension for the proof mass.

17. An inertial sensor comprising:
a resonator body having a central mounting point;
a plurality of radial segment openings in the resonator body around the central mounting point;
a plurality of slot openings in the resonator body around the plurality of radial segment openings, wherein the plurality of slot openings are symmetrically arranged in the resonator body;
a plurality of excitation electrodes in at least four of the plurality of slot openings; and
a plurality of sensing electrodes in at least four of the plurality of slot openings.

18. The inertial sensor of claim 17, further comprising at least one tuning electrode in at least one of the plurality of slot openings.

19. The inertial sensor of claim 17, further comprising:
an end cap wafer and a base plate bonded to the planar resonator, and wherein the base plate supports the planar resonator at the central mounting point.

20. The inertial sensor of claim 17, wherein the plurality of slot openings comprise a plurality of inner slot openings and a plurality of outer slot openings, and wherein the plurality of excitation electrodes are in the plurality of outer slot openings, and wherein the plurality of sensing electrodes are in the plurality of inner slot openings.

21. The inertial sensor of claim 1, wherein vibration of the proof mass is induced via the excitation electrodes, used to measure the compliance and damping of the support and utilized to compensate for the measurement errors due to changes in compliance and damping.
